(19) United States
(12) Patent Application Publication
(10) Pub. No.: US 2023/0034965 A1
(43) Pub. Date: Feb. 2, 2023

(54) OFF GRID WIND TURBINE ELECTRIC VEHICLE CHARGING SYSTEM AND METHOD

(71) Applicant: VESTAS WIND SYSTEMS A/S, Aarhus N. (DK)

(72) Inventors: Catalin Gabriel DINCAN, Aalborg Øst (DK); Cem Özgür GERÇEK, Risskov (DK); Lars HELLE, Suldrup (DK); Philip Carne KJÆR, Aarhus C (DK)

(21) Appl. No.: 17/785,020

(22) PCT Filed: Dec. 1, 2020
(86) PCT No.: PCT/DK2020/050340

§ 371 Date: Jun. 13, 2022

(30) Foreign Application Priority Data
Dec. 11, 2019 (DK) PA 2019 70762

(51) Int. Cl. B60L 53/52; F03D 9/25; F03D 9/11; B60L 53/53; B60L 53/10; B60L 53/57; H02J 3/38

(52) U.S. Cl. CPC B60L 53/52; F03D 9/25; F03D 9/11; B60L 53/53; B60L 53/11; B60L 53/57; H02J 3/381; B60L 2210/30; H02J 2300/28

(57) ABSTRACT

An off grid electric system for charging electric vehicles. An electric storage system (BTS) is arranged to store electric power generated by a plurality of wind turbines. A plurality of electric vehicle charging stations are connected to the plurality of wind turbines, and the electric storage system by means of an off grid electric power network (CN), so as to allow each charging station to charge at least one electric vehicle (EV).

### FIELD OF THE INVENTION

The present invention relates to the field of wind turbine electric energy generation. Specifically, the invention relates to off grid technology for charging of electric vehicles with electric energy generated by wind turbines.

### BACKGROUND OF THE INVENTION

The number of electric vehicles (EVs) increases, and thus the need for electric energy for charging of batteries in the EVs increases. Wind turbine electric energy is an environmental friendly solution to provide energy for EV charging. However, especially solutions for charging large fleets of EVs such as taxis or high power trucks may be challenging with respect to charging capacity, availability of charging capacity when needed by the individual EV, and due to impact on collection and transmission network.

Further, for a large fleet of EVs, costs to provide electric power for charging via the public electric grid is significant.

Still further, e.g. fleets of high power EVs such as trucks, tractors, excavators may be required to operate at remote locations without grid connection, or with only a limited capacity of the grid connection.

Even further, off grid solutions for EV charging by electric power from a wind turbine exist, however still the capacity and flexibility of such systems is limited, and the technical solutions are rather complicated and therefore expensive both in installation and with respect to maintenance. Especially, the flexibility with respect to timing for charging and the capacity for the number of EVs that can be charged simultaneously are significant problems.

### SUMMARY OF THE INVENTION

Thus, according to the above description, it is an object of the present invention to provide a system and method for charging of fleets of EVs which is economical, has a high capacity, and still provides flexibility with respect to timing and number of EVs to be charged simultaneously.

In a first aspect, the invention provides an off grid electric system for charging EVs, the system comprising
a plurality of wind turbines arranged to generate respective electric power outputs,
an electric storage system arranged to store electric power generated by the plurality of wind turbines,
a plurality of EV charging stations each capable of charging at least one EV, and
an off grid electric power network serving to connect the electric power outputs of the plurality of wind turbines, the electric storage system, and the plurality of EV charging stations, so at to generate electric power to the plurality of EV charging stations to allow charging of EVs.

By ‘off grid electric system’ is understood a stand-alone electric system without connection to the public electric network or grid. Thus, an off grid electric system can operate without the need for switchgear and converter equipment required to allow compatibility connection to the grid. Such off grid electric system of wind turbines is advantageous for EV charging for a number of reasons. Since a significant amount of taxes/costs involved in buying electric energy from the grid can be eliminated when providing off grid wind turbine EV charging power, it can be expected that costs will be 50-75% cheaper compared to on grid EV charging. This means a significant cost reduction for owners of a large fleet of EVs.

According to the invention, various proposal for off grid wind turbine to DC charging solutions will be described, where a number of complex components can be eliminated compared to wind turbines for on grid operation. Especially, high voltage (HV) switchgear for grid operation can be eliminated. This reduces installation costs and reduces the need for maintenance. This helps to make it feasible to setup off grid wind turbine plants at locations without grid or with limited capacity grid.

The solutions offer a high degree of flexibility and planning or scheduling of EV charging, e.g. by a combination of a battery system which can be charged by the wind turbines and stored power in the battery system can be used for EV charging in periods with low wind speeds. Further, if a weather forecast is taken into account, especially a wind speed prognosis, it may even be possible to plan EV charging of a fleet of EVs with very small battery capacity or even without the need for batteries.

The proposed solutions are especially suitable for wind turbines of such as 1-15 MW or even larger.

In the following, preferred embodiments and features will be described.

In preferred embodiment, the system has at least one wind turbine comprising an electric generator arranged, such as a permanent magnet electric generator, to generate a Medium Voltage (MV) AC output, such as a 4 kV to 8 kV AC voltage output. Especially, generators with a capacity of 3-8 MW may be preferred. Especially, the wind turbine may comprise an AC-DC converter connected to said MVAC output to generate a DC electric power output. Several technical solutions are available for such AC-DC converter, such as a two-level, a three-level or a modular multi-level AC-DC converter. It may be preferred that the AC-DC converter is arranged down-tower, such as in an enclosure or kiosk down-tower, either inside or outside the tower of the wind turbine.

In the following, four different series of embodiments will be described with different solutions with respect to the off grid electric power network connecting wind turbines, electric storage system, and vehicle charging stations.

In a first series of embodiments, the AC-DC converter is connected to a series connection of inputs of a plurality of separate DC-DC converters, wherein outputs of said separate DC-DC converters are connected to respective EV charging stations. Especially, the electric storage may comprise a re-chargeable battery system comprising a battery converter, wherein the battery converter is connected to the output of the AC-DC converter. The DC-DC converter and the re-chargeable battery system may be arranged together in an enclosure away from the at least one wind turbine, such as in the vicinity of the at least one wind turbine, e.g. within 25 ET) from the tower of the wind turbine. Specifically, the separate DC-DC converters may each comprise dual active bridge DC-DC converter or a resonant type DC-DC converter.

In a second series of embodiments, a monolithic DC-DC converter is connected to an output of the AC-DC converter, wherein the monolithic DC-DC converter has multiple sets of DC output terminals for separate charging of a plurality of EVs. Especially, the DC-DC converter may be placed away from the wind turbine, such as 25-500 m away from the wind turbine tower, and the monolithic DC-DC converter may be arranged inside an enclosure, such as a kiosk 10-1,000 m, e.g. 25-500 m, away from the at least one wind turbine, i.e. a kiosk separate from the enclosure or kiosk housing the AC-DC converter. The monolithic DC-DC converter preferably both has a monolithic primary side and a monolithic secondary side. An input of the monolithic DC-DC converter may be connected to a re-chargeable battery system.

In a third set of embodiments, a DC-DC converter is connected to an output of said AC-DC converter, wherein a primary side of the DC-DC converter is monolithic, wherein a secondary side of the DC-DC converter is modular and has multiple sets of DC output terminals for separate charging of a plurality of EVs, Especially, the monolithic DC-DC converter may be placed away from the wind turbine, such as the monolithic DC-DC converter being arranged inside an enclosure at a distance of 10-1,000 m, e.g. 25-500 m away from the wind turbine. Specifically, the DC-DC converter may comprise a transformer, and wherein a re-chargeable battery system is connected to a primary side of said transformer.

In a fourth set of embodiments, the MVAC output of the wind turbine is connected to a plurality of modules, wherein each of the modules comprises
a modular converter arrangement comprising an AC-DC converter connected to said Medium Voltage AC output,
a DC-DC converter arranged to provide a DC output for charging an EV in response to said AC-DC converter output, and
a re-chargeable battery system comprising a battery converter system connected to said DC-DC converter, and wherein said DC-DC converter shares one transformer with the battery converter system.

Specifically, the MVAC output of the wind turbine is connected to a plurality of sets of modules, wherein each set of modules comprises a series connection of a plurality of modules. Such as three sets of modules, wherein each set of modules is connected between two output phases of the wind turbine generator. The modules may be located such as 10-1,000 m away from the wind turbine, such as 25-500 m away from the wind turbine.

It is to be understood that sets of embodiments may comprise any of the mentioned features for the preferred embodiments, and it is further to be understood that the mentioned features and preferred embodiments can be combined.

In general, the off grid system comprises a control system arranged to control distribution of electric energy to the plurality of vehicle charging stations according to a control algorithm. Especially, the control system may be arranged to control distribution of electric energy from at least one wind turbine and to or from the electric storage system. Especially, the control system is arranged to receive information indicative of a weather forecast, and to apply said information to the control algorithm. Such weather forecast information can be used by a fleet owner to plan charging of a fleet of EVs, e.g. to charge partially charged EVs in advance in periods where wind power is available, in case the forecast predicts a period with low wind speed. In periods with low wind speed, the period for charging one EV may be increased, whereas rapid charging can be offered if wind power is available. Thus, such weather forecast information can be used to optimize utilization of the off grid wind power for EV charging, thus helping to relax requirement for electric storage capacity, or even allow fleet EV charging without the need for electric storage. Specifically, the information may comprise at least information indicative of a forecast of wind speed at a position of the wind turbine. Especially, the control algorithm may be arranged to predict an available electric energy available from the plurality of wind turbines in response to the information indicative of the weather forecast, and to control distribution of electric energy to the plurality of vehicle charging stations and to or from the electric storage system accordingly. Specifically, the control algorithm may be arranged to predict an available electric energy available from the plurality of wind turbines, and to generate a plan for charging of EVs accordingly. E.g. the control system may generate a plan with a determined number of vehicles to be charged in predetermined time slots, and/or plan a charging time for charging of EVs in accordance with an available electric energy and/or in accordance with an input indicative of a number of vehicles waiting to be charged.

In embodiments comprising a weather forecast input, the wind turbines may be connected directly to a plurality of EVs through a charging network, bypassing or not even needing local charging stations. The scheduling of charging of the EVs can be made before hand corresponding to the weather forecast.

In general, it may be preferred that the plurality of EV charging stations have a total capacity for simultaneous charging of at least 10 vehicles, such as at least 50 vehicles. The system may have at least 10 separate vehicle charging stations.

A preferred range of DC voltage to be applied to charge the EVs by each charging station is 500-1,500 V, more preferably 8004,000 V.

In preferred embodiments, the electric storage system comprises a battery system comprising a plurality of battery modules each comprising a plurality of re-chargeable battery cells, such as Li-ion based cells or other suitable technology cells. However, it is to be understood that the electric storage system may be based on one or more storage technology other than electro-chemical batteries. Especially, the electric storage system may comprise a combination of two or more different storage technologies, e.g. a combination of electro-chemical batteries and one or more alternative technologies. Specific examples are: flywheel energy storage, chemical storage via fuel cell technology, or thermal storage. Another example is liquid methanol or hydrogen storage tanks connected in parallel to electro-chemical storage units.

The total energy capacity of electric storage system may be such as 1 MWh to 100 MWh.

The wind turbines of the off grid system preferably comprises a rotor blade system, a permanent magnet electric generator connected to be driven by the rotor blade system, a tower with a nacelle for housing the electric generator, and an electric output capable of generating an electric power of at least 1 MW, such as at least 3 MW, such as 3-8 MW, such as 8 MW or more. Preferably, the electric generator is an AC generator, and wherein an AC-DC converter is not placed inside the nacelle of the wind turbines, but placed either down-tower or in an enclosure outside the wind turbine.

The off grid electric power network may be arranged to combine the AC or DC electric power outputs of the plurality of wind turbines into DC electric outputs to be applied to the EV charging stations. Hereby, a fault in one wind turbine still allows operation of all vehicle charging stations. Alternatively, the electric power network is split into separate off grid networks for the respective wind turbines, such that each wind turbine powers a plurality of vehicle charging stations via its own off grid power network.

In general, by MV AC is understood an AC voltage of 0.6-69 kV. A preferred range is 2-20 kV, such as 3-8 kV.

The type of EVs to be charged may be such as: cars for person transport, buses, vans, trucks, tractors, excavators, UAVs (drones), agricultural machines, trains, ships or even airplanes. Specific examples are: mining trucks or mining excavators.

In a second aspect, the invention provides a method for off grid charging an EV, the method comprising
generating Medium Voltage AC electric power outputs by a plurality of wind turbines,
providing an electric storage system arranged to store electric power generated by the plurality of wind turbines,
providing an off grid electric power network comprising an AC-DC converter,
connecting the electric power outputs from the plurality of wind turbines, and the electric storage system to a plurality of EV charging stations by means of said off grid electric power network, and
charging the EV by electric connection to one of the plurality of EV charging stations.

It is to be understood that the same advantages and preferred embodiments and features apply for the second aspect, as described for the first aspect, and the aspects may be mixed in any way.

### BRIEF DESCRIPTION OF THE FIGURES

The invention will now be described in more detail with regard to the accompanying figures of which

FIG. 1 illustrates a wind turbine,

FIG. 2 illustrates a block diagram of one embodiment,

FIGS. 3-6 illustrate electric diagrams of various embodiments,

FIGS. 7-10 illustrate configurations of various embodiments, and

FIG. 11 illustrates steps of a method embodiment,

The figures illustrate specific ways of implementing the present invention and are not to be construed as being limiting to other possible embodiments falling within the scope of the attached claim set.

### DETAILED DESCRIPTION OF THE INVENTION

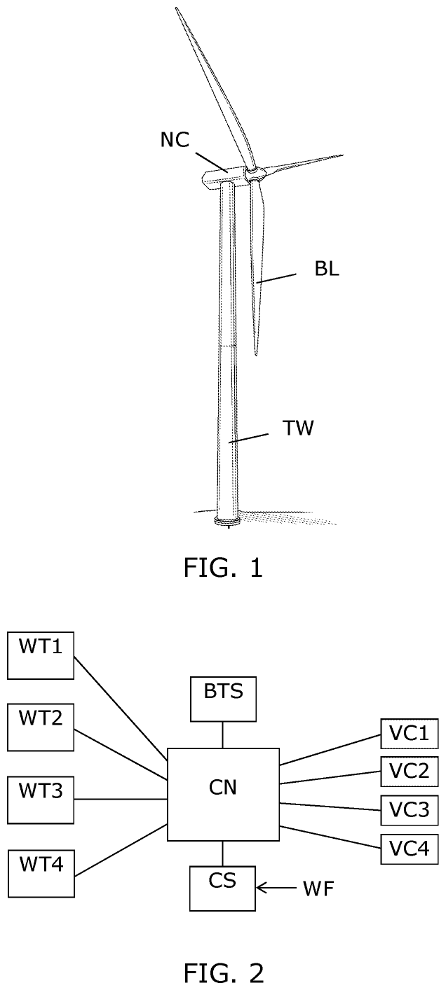

FIG. 1 illustrates a wind turbine system embodiment. The wind turbine has typically two or three rotor blades BL for driving an electric generator located inside the nacelle NC on top of a tower TW, Wind turbines may generate an electric power of at least 1 MW, such as 2-10 MW, or more.

In the context of the present invention, a preferred wind turbine has a permanent magnet electric generator that can generate an AC voltage of 2-10 kV, such as 4-8 kV, A power converter system with a filter and an AC-DC converter is preferably down-tower, e.g. in an enclosure inside the tower TW or in a separate enclosure outside the tower TW, such as a kiosk, e.g. at a distance of 5-50 m from the tower TW, The AC-DC converter may be a two-level, a three-level or a modular multi-level converter (MMC). For the present invention, it may be preferred that each wind turbine has a power capacity of such as 3-8 MW.

FIG. 2 shows a block diagram of a basic off grid electric system embodiment of the invention. A plurality of wind turbines WT1, WT2, WT3, WT4 generate respective electric power outputs to an off grid electric power network CN. This off grid electric power network CN serves to connect the outputs of the wind turbines WT1, WT2, WT3, WT4, a battery system BTS with re-chargeable battery cells, and a plurality of EV charging stations VC1, VC2, VC3, VC4 each capable of charging at least one EV. Hereby, the wind turbines WT1, WT2, WT3, WT4 can generate power to the rechargeable battery system BTS as well as the vehicle charging stations VC1, VC2, VC3, VC4. Further, in periods with low wind speeds, electric power from the battery system BTS can be applied to the vehicle charging stations VC1, VC2, VC3, VC4.

A control system CS having a processor system arranged to executed a control algorithm serves to control the off grid electric power network CN. The control system CS receives information indicative of a weather forecast WF, thereby allowing estimation of electric energy available from the wind turbines WT1, WT2, WT3, WT4 and the battery system BTS to charge a fleet of EVs for a period of time. With further input, e.g. online, regarding updated charge state and location of all single EVs of an EV fleet, the control system CS may be programmed to automatically generate a plan or schedule for charging of each single EV of the fleet. The EVs may be automatically called towards a specific one of the vehicle charging stations VC1, VC2, VC3, VC4 to a specific time, so as to avoid waiting time for charging. Further, in periods with high electric energy capacity, a rapid charging may be offered, while a slower charging time may be offered in periods with less electric energy available.

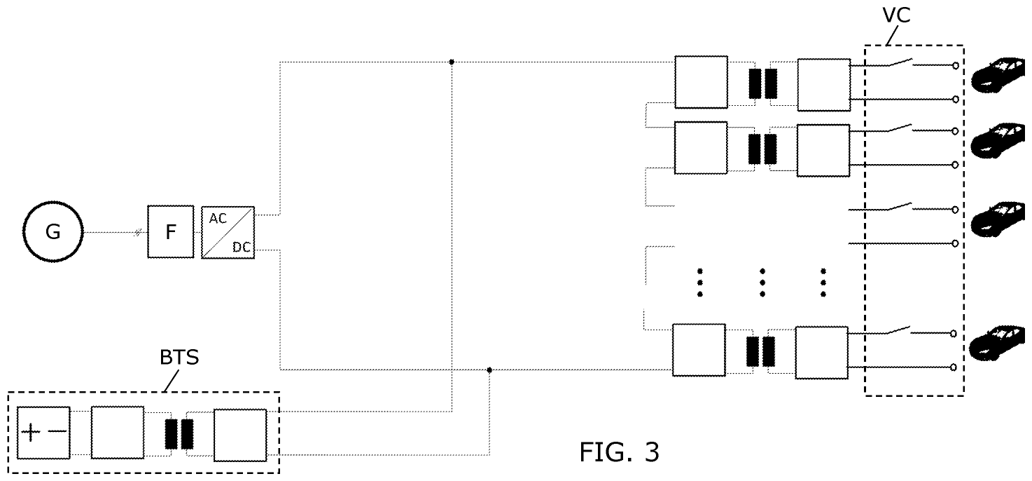

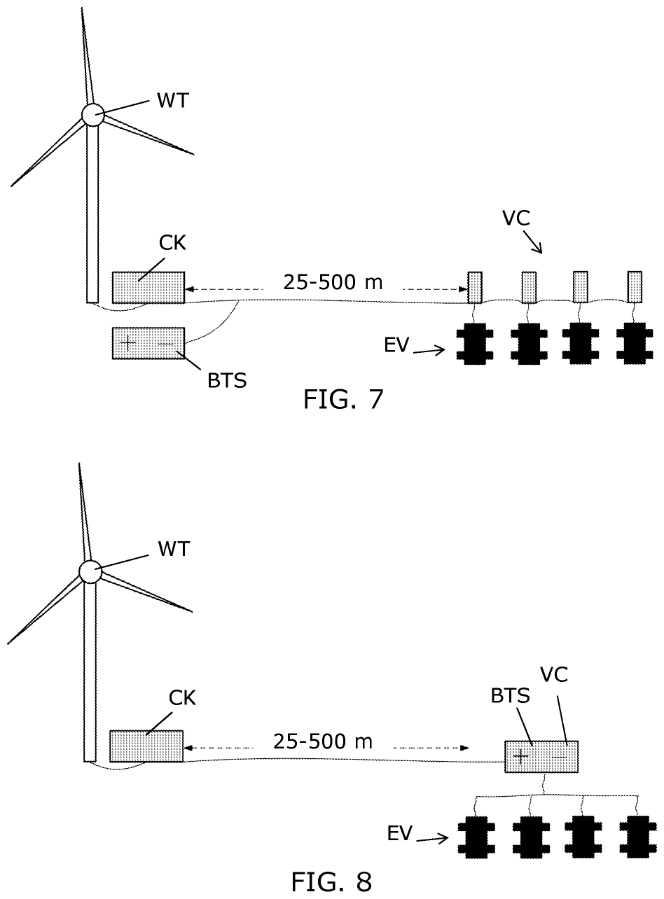

In the following, four different technical configurations of the off grid electric power connection network CN will be described for one single wind turbine, as examples, FIGS. 3-6 show four electric diagrams of different embodiments, all four embodiments have in common that the wind turbine has an electric generator G arranged to generate a MVAC output, e.g. an 4-8 kV AC, and an AC-DC converter connected to the MVAC output via a filter F to generate a DC electric power output. Further, one or more re-chargeable batteries B or re-chargeable battery systems BTS are included in all four embodiments. In all four embodiments, the wind turbine itself can be rather simple, e.g. without the need for a converter installed inside the nacelle, which facilitates installation and maintenance. FIGS. 7-10 show examples of physical layouts of the components of the four embodiments.

FIG. 3 shows a first off grid electric system embodiment the output of the AC-DC converter is connected to a series connection of inputs of a plurality of separate DC-DC converters, wherein outputs of said separate DC-DC converters are connected to respective EV charging stations VC. Further, a re-chargeable battery system BTS comprising a battery converter, wherein the battery converter is connected to said output of said AC-DC converter. Thus, this embodiment has separate DC-DC converters for each charging stations VC is provided, and the battery system BTS can be located separate from the wind turbine and also separate from the AC-DC converter. Each of the DC-DC converters may especially be dual active bridge type converters or resonant type converters. It may be preferred that the AC-DC converter is placed down-tower, e.g. in a first kiosk in the vicinity of the wind turbine, while a second kiosk may house the battery system BTS. The charging stations VC may be located 25-500 m further away from the first kiosk.

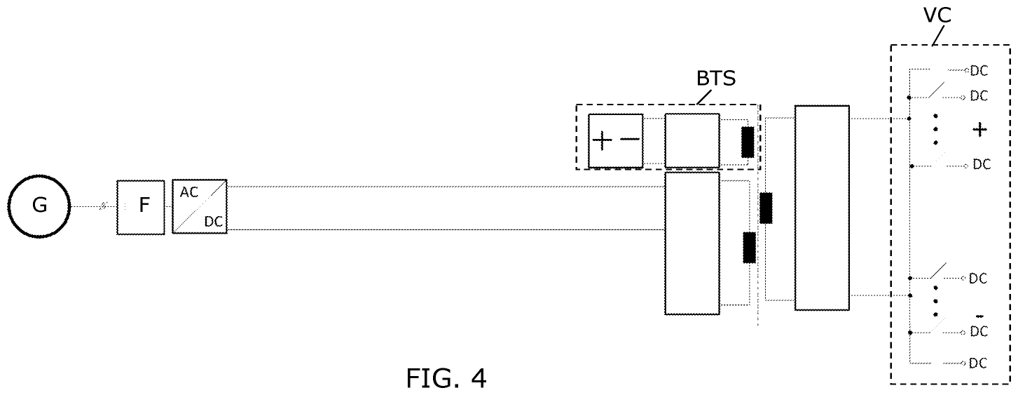

FIG. 4 shows a second off grid electric system embodiment with a monolithic DC-DC converter connected to the output of the AC-DC converter. The monolithic DC-DC converter has multiple sets of DC output terminals (i.e. multiple sets of + and − terminals) for separate charging of a plurality of EVs, thus providing separate charging stations VC. An input of the monolithic DC-DC converter is connected to a re-chargeable battery system BTS. Also in this embodiment, the AC-DC converter is preferably placed down-tower, e.g. in a kiosk in the vicinity of the wind turbine. At a distance of 25-500 m further away from the kiosk, the monolithic converter can be placed in a second kiosk. The battery system BTS may be placed also in the second kiosk or in a separate enclosure or kiosk.

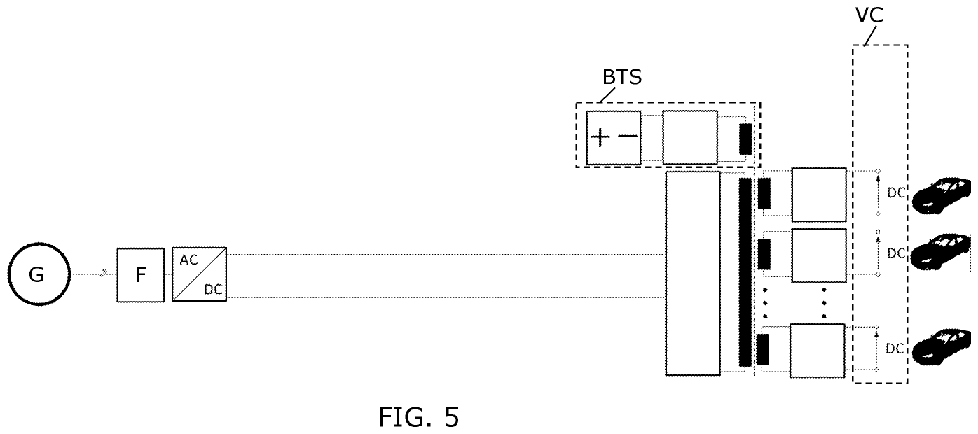

FIG. 5 shows a third off grid electric system embodiment comprising a DC-DC converter connected to the output of the AC-DC converter, where the primary side of the DC-DC converter is monolithic, whereas the secondary side of the DC-DC converter is modular and has multiple sets of DC output terminals for separate charging of a plurality of EVs, thus providing the vehicle charging stations VC. The DC-DC converter comprises a transformer, and a re-chargeable battery system BTS is connected to the primary side of this transformer. Again, the AC-DC converter is preferably placed down-tower, e.g. in a kiosk in the vicinity of the wind turbine. At a distance of 25-500 m further away from the kiosk, the monolithic converter can be placed in a second kiosk. The battery system BTS may be placed also in the second kiosk or in a separate enclosure or kiosk.

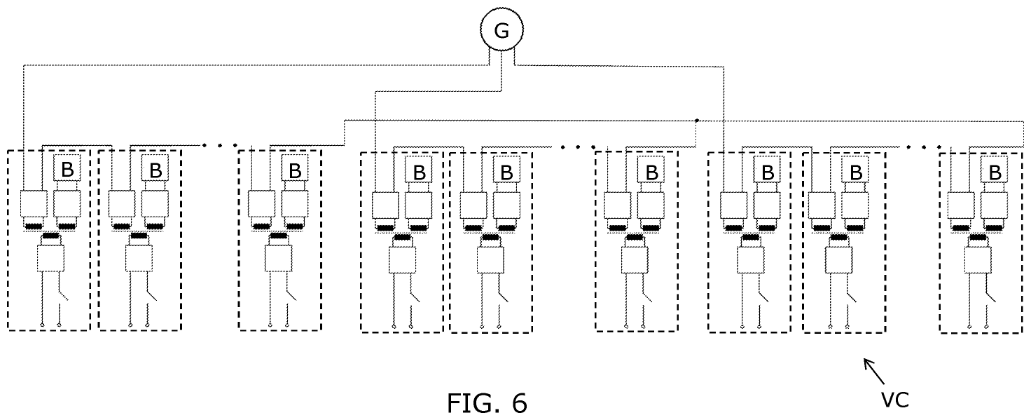

FIG. 6 show a fourth off grid electric system embodiment where the MVAC output from the wind turbine generator G is connected to a plurality of modules VC each indicated by dashed lines. Each module has a modular converter arrangement comprising an AC-DC converter connected to the MVAC output of the generator G, a DC-DC converter arranged to provide a DC output for charging an EV in response to the AC-DC converter output, and a re-chargeable battery system B with a battery converter system connected to the DC-DC converter, and wherein the DC-DC converter shares one transformer with the battery converter system. As seen, the MVAC output is connected to a plurality of sets of modules VC, each set of modules comprising a series connection of a plurality of modules VC. Each module VC may have its own enclosure or kiosk.

FIG. 7 shows an example of physical configuration of the first embodiment, where a first kiosk CK with the AC-DC converter is placed in vicinity of the wind turbine WT, and further in a separate kiosk BTS the re-chargeable battery system is housed, also located in the vicinity of the wind turbine WT. At a distance of 25-500 m away from the first kiosk CK, separate enclosures are provided for the charging stations VC each capable of charging an EV.

FIG. 8 shows an example of physical configuration of the second or third embodiments. This is similar to the configuration in FIG. 7, except that the battery system BTS and the DC-DC converter system with charging station outputs VC are housing within one common enclosure, an enclosure placed 25-500 m away from the kiosk CK housing the AC-DC converter.

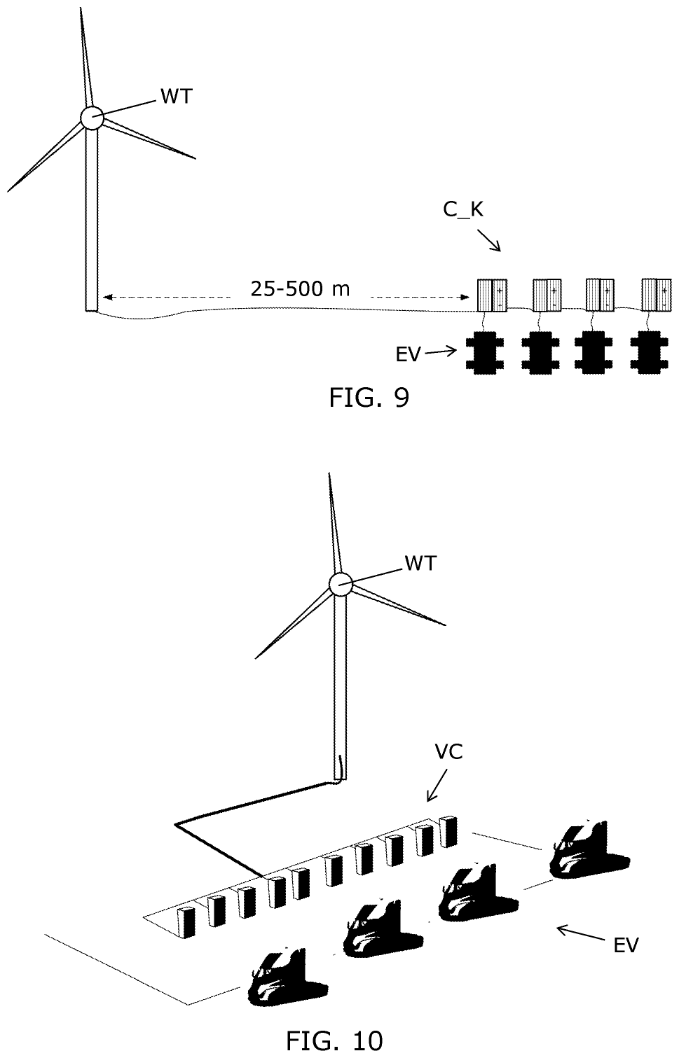

FIG. 9 shows an example of physical configuration of the fourth embodiment, where separate enclosures C K, e.g. kiosks, placed 25-500 m away from the wind turbine, each houses AC-DC converter, DC-DC converter as well as re-chargeable battery system. This setup is simple, since the enclosures with all elements contained therein can be mass produced and pre-manufactured for installation on site.

FIG. 10 shows another example of physical configuration, e.g. an implementation of the fourth embodiment, where a line of EV charging stations VC is placed within e.g. 500 m away from the wind turbine WT, thus allowing charging of a fleet of many EVs simultaneously.

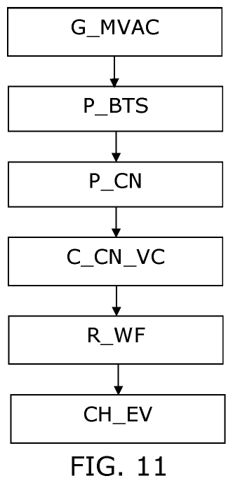

FIG. 11 illustrates steps of an embodiment for a method off grid charging an EV. The method comprises generating G_MVAC MVAC electric power outputs by a plurality of wind turbines. Further, providing P BTS an electric storage system arranged to store electric power generated by the plurality of wind turbines, e.g. a high capacity Li-ion battery. Further, providing P_CN an off grid electric power network comprising an AC-DC converter, and connecting C_CN_VC the electric power outputs from the plurality of wind turbines, and the electric storage system to a plurality of EV charging stations by means of said off grid electric power network. Then, receiving R_WF a weather forecast with predicted wind speeds for the location of the wind turbines, thus allowing prediction of wind turbine power available, thereby allowing selection of a mix of electric power from the electric storage system and the wind turbines for charging of an EV. Finally, charging the EV by electric connection to one of the plurality of EV charging stations. Especially, such the method embodiment is advantageous for charging a fleet of EVs, where it is possible to automatically plan EV charging based on the predicted electric wind turbine power available versus time.

Although the present invention has been described in connection with the specified embodiments, it should not be construed as being in any way limited to the presented examples. The scope of the present invention is to be interpreted in the light of the accompanying claim set. In the context of the claims, the terms “including” or “includes” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

1. An off grid electric system for charging electric vehicles (EV), the system comprising:
a plurality of wind turbines arranged to generate respective electric power outputs;
an electric storage system arranged to store electric power generated by the plurality of wind turbines;
a plurality of electric vehicle charging stations each capable of charging at least one electric vehicle (EV); and
an off grid electric power network (CN) serving to connect the electric power outputs of the plurality of wind turbines, the electric storage system (BTS), and the plurality of electric vehicle charging stations, so at to generate electric power to the plurality of electric vehicle charging stations to allow charging of electric vehicles (EV).

2. The off grid electric system according to claim 1, wherein at least one of the plurality of wind turbines comprises an electric generator arranged to generate a Medium Voltage AC output.

3. The off grid electric system according to claim 2, further comprising an AC-DC converter connected to said Medium Voltage AC output to generate a DC electric power output.

4. The off grid electric system according to claim 3, wherein said output of said AC-DC converter is connected to a series connection of inputs of a plurality of separate DC-DC converters, wherein outputs of said separate DC-DC converters are connected to respective electric vehicle charging stations.

5. The off grid electric system according to claim 4, further comprising a re-chargeable battery system (BTS) comprising a battery converter, wherein the battery converter is connected to said output of said AC-DC converter.

6. The off grid electric system according to claim 3, further comprising a monolithic DC-DC converter connected to an output of said AC-DC converter, wherein the monolithic DC-DC converter has multiple sets of DC output terminals for separate charging of a plurality of electric vehicles.

7. The off grid electric system according to claim 6, wherein an input of the monolithic DC-DC converter is connected to a re-chargeable battery system (BTS).

8. The off grid electric system according to claim 3, further comprising a DC-DC converter connected to an output of said AC-DC converter, wherein a primary side of the DC-DC converter is monolithic, wherein a secondary side of the DC-DC converter is modular and has multiple sets of DC output terminals for separate charging of a plurality of electric vehicles.

9. The off grid electric system according to claim 8, wherein the DC-DC converter comprises a transformer, and wherein a re-chargeable battery system (BTS) is connected to a primary side of said transformer.

10. The off grid electric system according to claim 2, wherein said Medium Voltage AC output is connected to a plurality of modules, wherein each of the modules comprises:
a modular converter arrangement comprising an AC-DC converter connected to said Medium Voltage AC output;
a DC-DC converter arranged to provide a DC output for charging an electric vehicle in response to said AC-DC converter output; and
a re-chargeable battery system (BTS) comprising a battery converter system connected to said DC-DC converter, and wherein said DC-DC converter shares one transformer with the battery converter system.

11. The off grid electric system according to claim 10, wherein said Medium Voltage AC output is connected to a plurality of sets of modules, wherein each set of modules comprises a series connection of a plurality of modules.

12. The off grid electric system according to claim 1, further comprising a control system (CS) arranged to control distribution of electric energy to the plurality of vehicle charging stations according to a control algorithm, wherein the control system is arranged to receive information indicative of a weather forecast (WF), and to apply said information to the control algorithm.

13. The off grid electric system according to claim 12, wherein the control algorithm is arranged to predict an available electric energy available from the plurality of wind turbines in response to the information indicative of the weather forecast, and to control distribution of electric energy to the plurality of vehicle charging stations and to or from the electric storage system accordingly.

14. The off grid electric system according to claim 12, wherein the control algorithm is arranged to predict an available electric energy available from the plurality of wind turbines, and to generate a plan for charging of electric vehicles accordingly.

15. A method for off grid charging an electric vehicle, the method comprising:
generating Medium Voltage AC electric power outputs by a plurality of wind turbines;
providing an electric storage system arranged to store electric power generated by the plurality of wind turbines;
providing an off grid electric power network comprising an AC-DC converter;
connecting the electric power outputs from the plurality of wind turbines, and the electric storage system to a plurality of electric vehicle charging stations by means of said off grid electric power network; and
charging the electric vehicle by electric connection to one of the plurality of electric vehicle charging stations.

16. The method of claim 15, wherein at least one of the plurality of wind turbines comprises an electric generator arranged to generate a Medium Voltage AC output.

17. The method of claim 16, further comprising an AC-DC converter connected to said Medium Voltage AC output to generate a DC electric power output.

18. The method of claim 17, wherein said output of said AC-DC converter is connected to a series connection of inputs of a plurality of separate DC-DC converters, wherein outputs of said separate DC-DC converters are connected to respective electric vehicle charging stations.

19. The method of claim 18, further comprising a re-chargeable battery system (BTS) comprising a battery converter, wherein the battery converter is connected to said output of said AC-DC converter.

20. The method of claim 17, further comprising a monolithic DC-DC converter connected to an output of said AC-DC converter, wherein the monolithic DC-DC converter has multiple sets of DC output terminals for separate charging of a plurality of electric vehicles.
